(19) United States
(12) Patent Application Publication
(10) Pub. No.: US 2026/0351009 A1
(43) Pub. Date: Nov. 5, 2026

(54) IMAGE GENERATION SYSTEM, IMAGE GENERATION METHOD AND RECORDING MEDIUM FOR RECORDING PROGRAM

(71) Applicant: NEC Corporation, Minato-ku, Tokyo (JP)

(72) Inventors: Chisato SUGAWARA, Tokyo (JP); Yusuke MIZUKOSHI, Tokyo (JP); Yoshihiro NISHIKAWA, Tokyo (JP); Yuta SHIMIZU, Tokyo (JP)

(73) Assignee: NEC Corporation, Minato-ku, Tokyo (JP)

(21) Appl. No.: 19/105,100

(22) PCT Filed: Oct. 27, 2022
(86) PCT No.: PCT/JP2022/040099

§ 371 Date: Feb. 20, 2025

(51) Int. Cl. G06V 20/56; G06T 7/00; G06T 7/13; G06T 11/23

(52) U.S. Cl. CPC G06V 20/588; G06T 7/0002; G06T 7/13; G06T 11/23; G06T 2207/30242; G06T 2207/30256

(57) ABSTRACT

An image generation system according to an aspect of the present disclosure includes: at least one memory storing instructions; and at least one processor configured to execute the instructions to: acquire a road surface image in which a road surface is imaged; recognize road surface deterioration from the road surface image; predict future damage occurring on the imaged road surface based on a state of the recognized road surface deterioration; generate a predicted image representing the predicted damage on the road surface using the road surface image; and output the predicted image.

### TECHNICAL FIELD

The present disclosure relates to a road image generation system and the like.

### BACKGROUND ART

On a paved road, deterioration such as cracking, pot holes, rutting, and the like occurs due to factors such as traveling of a vehicle and rainfall. Therefore, in order to grasp a deterioration situation of a road and plan repair of the road, a situation of the road is analyzed. PTL 1 discloses a method of making a repair plan when local uneven sinking of a paved road reaches a predetermined sinking amount value. The sinking amount is calculated by measuring the height of the road surface using the optical cutting photographing device.

PTL 2 discloses a deterioration prediction system that superimposes and displays a predicted deterioration level on a road on a map in a display mode according to the deterioration level. The deterioration level is displayed, for example, in three stages of large, medium, and small.

### CITATION LIST

### Patent Literature

PTL 1: JP 2017-101416 A

PTL 2: WO 2021/192790 A1

### SUMMARY OF INVENTION

### Technical Problem

It may be difficult to imagine the appearance of a road in which predicted damage occurs as in PTLs 1 and 2. For example, in a case where a pot hole is predicted to occur, a user who plans repair of a road does not know what kind of pot hole will occur at which position on a road surface.

An object of the present disclosure is to provide an image generation system and the like capable of presenting a future state of a road surface in an easy-to-understand manner.

### Solution to Problem

An image generation system according to the present disclosure includes: an acquisition means for acquiring a road surface image in which a road surface is imaged; a recognition means for recognizing road surface deterioration from the road surface image; a prediction means for predicting future damage occurring on the imaged road surface based on a state of the recognized road surface deterioration; a generation means for generating a predicted image representing the predicted damage on the road surface using the road surface image; and
an output means for outputting the predicted image.

An image generation method according to the present disclosure includes: acquiring a road surface image in which a road surface is imaged; recognizing road surface deterioration from the road surface image; predicting damage occurring in a future on the captured road surface based on a state of the recognized road surface deterioration; generating a predicted image representing the predicted damage on the road surface using the road surface image; and outputting the predicted image.

A program according to the present disclosure causes a computer to execute: acquiring a road surface image in which a road surface is imaged; recognizing road surface deterioration from the road surface image; predicting damage occurring in a future on the captured road surface based on a state of the recognized road surface deterioration; generating a predicted image representing the predicted damage on the road surface using the road surface image; and outputting the predicted image. The program may be stored in a non-transitory recording medium which can be computer-readable.

### Advantageous Effects of Invention

According to the present disclosure, a future state of a road surface can be presented in an easy-to-understand manner.

### BRIEF DESCRIPTION OF DRAWINGS

FIG. 1 is a block diagram illustrating a configuration example of an image generation system according to a first example embodiment.

FIG. 2 is a flowchart illustrating an operation example of the image generation system according to the first example embodiment.

FIG. 3 is a diagram illustrating an outline of a device connected to the image generation system.

FIG. 4 is a diagram illustrating an example of a road surface image.

FIG. 5 is a diagram illustrating an example of a recognition result of a road surface and damage.

FIG. 6 is a diagram illustrating a result of extracting lateral cracks.

FIG. 7 is a diagram illustrating a region for predicting lateral cracks.

FIG. 8 is a diagram illustrating a result of integrating specified regions.

FIG. 9 is a diagram illustrating an example of a label image.

FIG. 10 is a diagram illustrating a result of superimposing predicted lateral cracks on a damage recognition result.

FIG. 11 is a diagram illustrating an example of a predicted image.

FIG. 12 is a flowchart illustrating an operation example of an image generation system according to a second example embodiment.

FIG. 13 is a diagram illustrating a method of expanding a region for predicting lateral cracks.

FIG. 14 is a diagram illustrating a result of integrating specified regions in a case where a region for predicting lateral cracks is expanded.

FIG. 15 is a flowchart illustrating an operation example of an image generation system according to a third example embodiment.

FIG. 16 is a diagram illustrating a result of extracting longitudinal cracks.

FIG. 17 is a diagram illustrating a result of superimposing predicted longitudinal cracks on a damage recognition result.

FIG. 18 is a block diagram illustrating an example of a hardware configuration of a computer.

### EXAMPLE EMBODIMENT

### First Example Embodiment

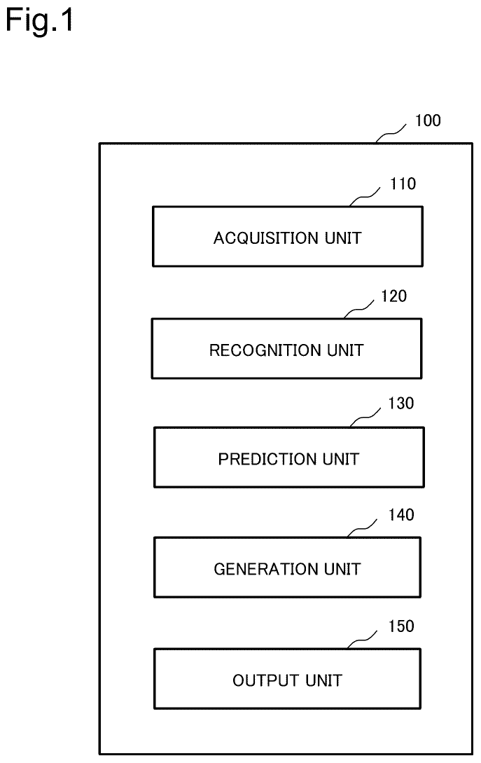

FIG. 1 is a block diagram illustrating a configuration example of an image generation system 100 according to a first example embodiment. The image generation system 100 includes an acquisition unit 110, a recognition unit 120, a prediction unit 130, a generation unit 140, and an output unit 150.

The acquisition unit 110 acquires a road surface image obtained by photographing a road surface. In addition to the road surface, the road surface image may include a surrounding landscape, a building, a structure, and a moving body such as a vehicle and a person. The acquisition unit 110 may acquire an image captured by an imaging device installed in the moving body. The imaging device is, for example, a camera mounted on a moving body such as an automobile, a bicycle, and a drone. However, how the road surface image is captured is not particularly limited. The road surface image may be captured by a camera held by a person's hand, or may be captured by a fixed camera installed on a road side.

The recognition unit 120 recognizes road surface deterioration from the road surface image acquired by the acquisition unit 110. The road surface deterioration is damage caused on the road surface. The recognition unit 120 recognizes road surface deterioration using a known image recognition technique for the road surface image. The recognition unit 120 may recognize the road surface deterioration using the learned model. The recognition unit 120 may recognize road surface deterioration by semantic segmentation, but a recognition method is not particularly limited.

The prediction unit 130 predicts damage occurring in the future on the captured road surface based on the state of road surface deterioration recognized by the recognition unit 120. The state of road surface deterioration is an index indicating a state of damage of the road surface. The state of road surface deterioration includes the position of the damage and the level of damage in the road surface image. The prediction of the damage is to predict the state of the damage occurring on the road surface in the future. The predicted damage state includes the type, shape, position, and size of the damage. The prediction unit 130 determines, for example, a label image representing the predicted damage from a database. The label image represents road surface deterioration recognized from a road surface image obtained by photographing another road surface.

The road surface deterioration progresses from a place where the damage has already occurred in many cases. Therefore, it is considered that the damage occurs in the vicinity of the damaged portion recognized in the road surface image in the future. It is considered that the level of damage will be worse in the future than the recognized damage.

As an example of the damage prediction based on the position of the damage in the state of road surface deterioration, the prediction unit 130 predicts that the damage occurs in the vicinity of the recognized damage. For example, the prediction unit 130 may predict future damage of an arbitrary size around the recognized damage. The prediction unit 130 may predict a derived damage from the position with the damage as a start point based on the position of the recognized damage. For example, the prediction unit 130 predicts that a crack extending in the length direction of the crack occurs from one end or both ends of the crack. Here, the damage predicted to occur may be damage continuous with the recognized damage or may be discontinuous damage.

Next, an example of damage prediction based on the level of damage in the state of road surface deterioration will be described. The level of damage can be evaluated based on the type of road surface deterioration. There are a plurality of types of damage in road surface deterioration. The road surface deterioration is classified into a plurality of types including, for example, cracks, pot holes, rutting, and flatness abnormality of the road. The classification of cracks may be further subdivided into linear cracks, tortoise-shell cracks, and the like depending on the shape. The linear crack is a single linear crack. Linear cracks can be further classified into lateral cracks and longitudinal cracks. The linear crack is also called a straight crack. The tortoise-shell crack is, for example, a tortoise-shell shaped crack generated when longitudinal and lateral linear cracks are connected. Cracks in the road are progressed to linear cracks, tortoise-shell cracks, and pot holes. Therefore, the level of damage of the linear crack is smaller than that of the tortoise-shell crack.

Various indexes are used as indexes indicating the level of damage. In the present disclosure, the level of damage is represented by a deterioration level. The deterioration level may be any one of indexes including a level of cracking, the number of pot holes, a size of the pot hole, or a rutting amount. The deterioration level may be determined based on a combination of a plurality of indexes indicating the level of road deterioration. The deterioration level increases when the state of the road surface deteriorates. The manner of representing the deterioration level is not limited to this, and for example, the value of the deterioration level may be reduced in a case where the state of the road surface deteriorates.

The level of cracking is represented by any one of a shape, a length, an area, and the number of cracks, or a combination thereof. The cracking rate is an example of the level of cracking. The cracking rate is represented by, for example, 100×(crack area/road surface area). In this case, the value of the deterioration level ranges from 0% to 100%. The crack area is calculated by any method. A method of calculating the cracking rate is not particularly limited, and a known calculation method can be applied in addition to the above.

The size of the pot hole is represented by, for example, any one of an area, a width, a length, and a depth of the pot hole, or a combination thereof. The rutting amount is an index indicating the depth of a groove generated in parallel with the road traveling direction when the traveling locus of the vehicle becomes lower than other road surfaces due to the load of the vehicle and friction with tires.

Based on the level of recognized damage, the prediction unit 130 may predict the size and type of damage to be generated. For example, the prediction unit 130 predicts that a tortoise-shell crack will occur in a region where the number of intersections between linear cracks is larger than a predetermined threshold or in a region near the region. The prediction unit 130 predicts that a pot hole will be generated in a region where the density of tortoise-shell cracks is higher than a predetermined threshold or in a region near the region. The density of tortoise-shell cracks is represented, for example, by the number of pixels indicating tortoise-shell cracks included in any range of regions.

The prediction unit 130 may predict damage occurring in the future for each type of damage. For example, the prediction unit 130 predicts a future lateral crack in a case where the current lateral crack progresses, and then predicts a future longitudinal crack in a case where the current longitudinal crack progresses. The order and timing for each type of damage are not particularly limited.

The method by which the prediction unit 130 predicts future damage based on the state of the recognized road surface deterioration is not limited to the above example. The damage prediction by the prediction unit 130 will be described in more detail in the second and third example embodiments.

The generation unit 140 generates a predicted image representing the damage predicted by the prediction unit 130 on the road surface using the road surface image. The generation unit 140 may generate the predicted image by superimposing a figure representing the predicted damage on the road surface image for each region. The generation unit 140 may generate the predicted image by synthesizing the label image representing the predicted damage and the road surface image.

A method of synthesizing the label image and the road surface image is not particularly limited. For example, the generation unit 140 may superimpose the label image on the road surface image. Alternatively, the generation unit 140 may superimpose the damaged portion of the label image on the road surface image.

The generation unit 140 may generate a predicted image by inputting a road surface image to a learning model generated by machine learning. For example, a Generative Adversarial Network (GAN) may be used as the machine learning model. However, the type of the machine learning model is not limited thereto.

The output unit 150 outputs the predicted image generated by the generation unit 140. For example, the output unit 150 outputs the predicted image to an arbitrary display.

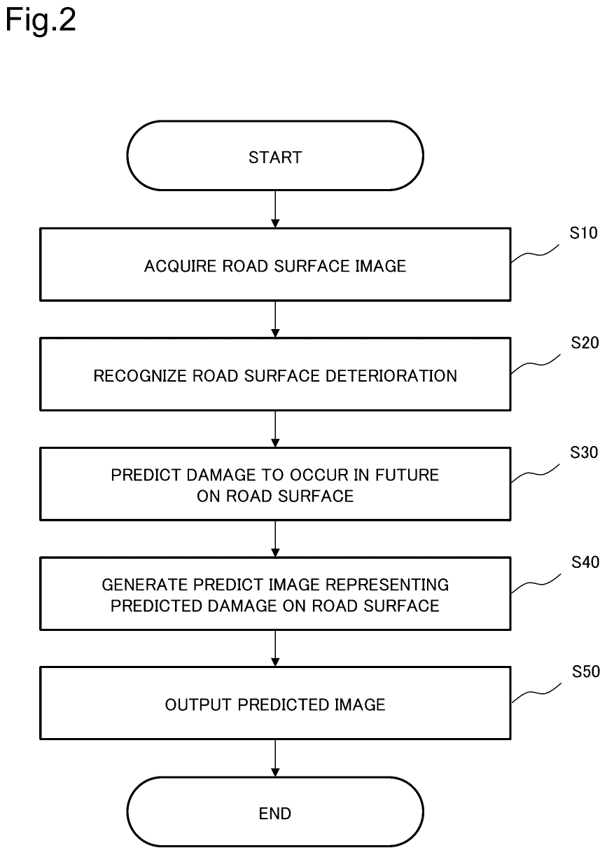

FIG. 2 is a flowchart illustrating an operation example of the image generation system 100 according to the first example embodiment. The image generation system 100 may start the operation of FIG. 2 according to the operation of the user using the input device.

The acquisition unit 110 acquires the road surface image obtained by capturing the road surface (step S10). The recognition unit 120 recognizes road surface deterioration from the road surface image acquired by acquisition unit 110 (step S20).

The prediction unit 130 predicts damage occurring in the future on the captured road surface based on the state of road surface deterioration recognized by the recognition unit 120 (step S30). The generation unit 140 generates a predicted image representing the damage predicted by the prediction unit 130 on the road surface using the road surface image (step S40).

The output unit 150 outputs the predicted image generated by the generation unit 140 (step S50). Thus, the image generation system 100 ends the operation of FIG. 2.

According to the first example embodiment, the acquisition unit 110 acquires a road surface image obtained by photographing a road surface, and the recognition unit 120 recognizes road surface deterioration from the road surface image. Then, based on the state of the recognized road surface deterioration, the prediction unit 130 predicts damage occurring in the future on the captured road surface. Further, the generation unit 140 generates a predicted image representing the predicted damage on the road surface using the road surface image. Therefore, a predicted image representing what kind of damage will occur at what kind of position on the road surface in the future is generated.

The prediction unit 130 predicts the damage based on the state of the recognized road surface deterioration, so that the generation unit 140 can generate the predicted image reflecting the actual damage occurrence tendency. Therefore, it is possible to present a predicted image more appropriate to the actual situation.

Further, according to the first example embodiment, the output unit 150 outputs the predicted image. Therefore, the future state of the road surface can be presented in an easy-to-understand manner. The output predicted images may be utilized, for example, to determine a budget for road repairs. Even if a predicted value of the future deterioration is presented as a numerical value, it is difficult for some people to understand the necessity of repair. Therefore, by presenting the predicted image as the future prediction result, the necessity of repair is convincing, and the budget for repair is appropriately set.

### Second Example Embodiment

Next, as a second example embodiment, an image generation system 100 will be described in more detail. Regarding the configuration of the second example embodiment, description of the same configuration as that of the first example embodiment will be omitted.

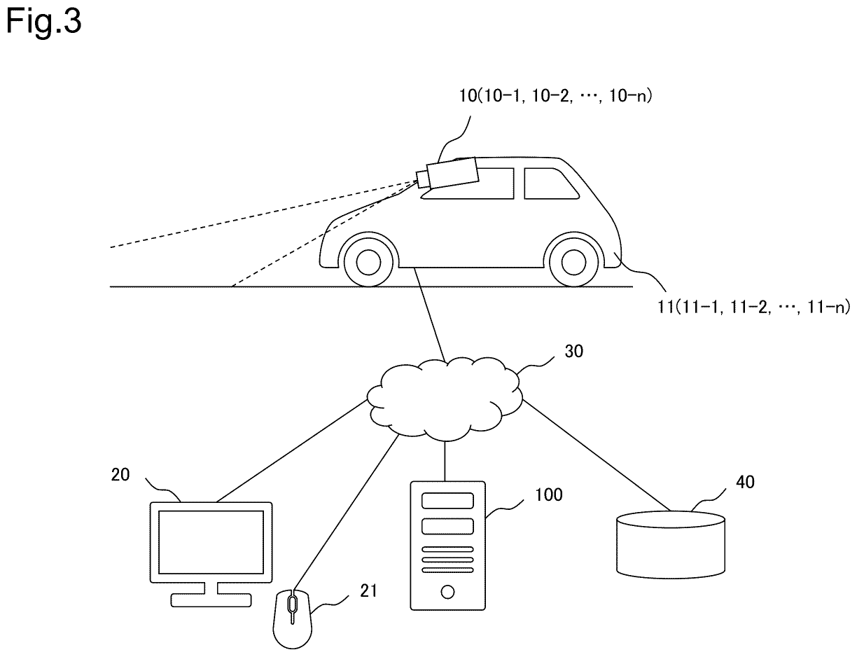

FIG. 3 is a diagram illustrating an outline of a device communicably connected to an image generation system 100 by wire or wirelessly via a communication network 30. The image generation system 100 is connected to, for example, an imaging device 10, a display 20, an input device 21, and a database 40.

The imaging device 10 is installed in a moving body 11, and captures an image including a road or a structure on the road. The imaging device 10 is achieved by, for example, a drive recorder mounted on an automobile. However, the type of the imaging device 10 is not limited thereto, and cameras provided in various types of moving bodies 11 may be used. For example, the image may be captured by a camera mounted on another moving body such as a bicycle or a drone.

In FIG. 3, one imaging device 10 and one moving body 11 are illustrated. However, the image generation system 100 may be connected to a plurality of imaging devices 10-1, . . . , 10-n installed in a plurality of moving bodies 11-1, . . . , 11-n. Here, n is a natural number of 2 or more.

The image captured by the imaging device 10 is stored in the database 40. The image may be a still image or a moving image captured by the imaging device 10 while the moving body 11 is moving. The image may be captured at a place designated by a person, or may be automatically captured at an arbitrary interval.

The display 20 displays information to the user. The display 20 includes, for example, a display, a tablet, and the like. The information to be displayed will be described later.

The input device 21 receives an operation from a user. The input device 21 includes, for example, a mouse, a keyboard, and the like. In a case where the display 20 is a touch panel display, the display 20 may be configured as the input device 21.

The database 40 further stores the road surface image captured by the imaging device 10. The database 40 may further store a label image representing the damage recognized from the road surface image. The database 40 may store label images of various pixel sizes. The label image may be stored in association with information indicating the type or level of damage indicated by the label image.

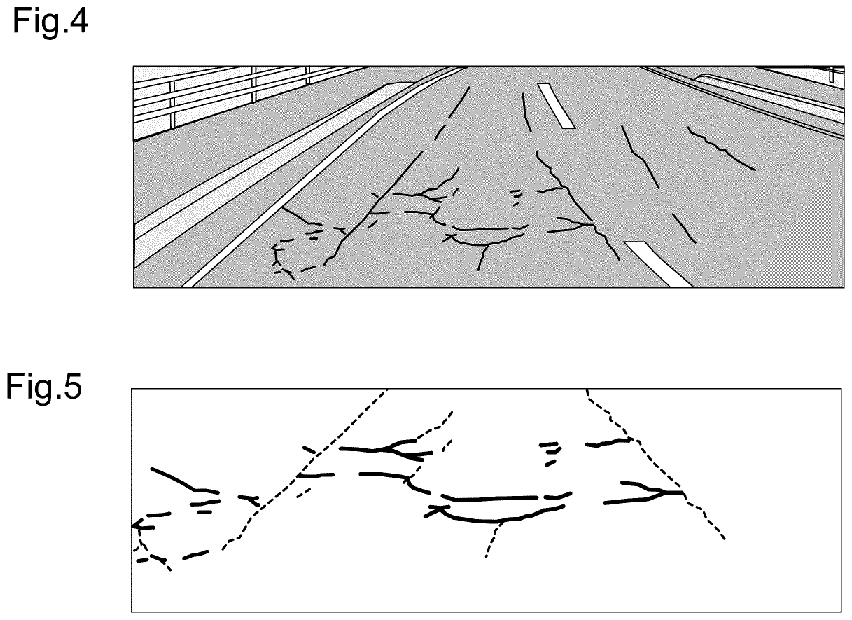

The acquisition unit 110 acquires the road surface image captured by the imaging device 10. FIG. 4 is a diagram illustrating an example of a road surface image. For example, the acquisition unit 110 acquires the road surface image from the database 40. In another example, the acquisition unit 110 may acquire the road surface image from the imaging device 10 via the communication network 30. At this time, the image generation system 100 is communicably connected to the imaging device 10 as necessary.

The acquisition unit 110 may acquire, together with the image, position information of a point where the image is captured. The position information includes, for example, latitude and longitude, position information obtained by a global navigation satellite system (GNSS) or a global positioning system (GPS), or a position on a map.

The acquisition unit 110 may acquire, together with the image, the date and time when the image is captured.

The recognition unit 120 recognizes road surface deterioration from the road surface image. For example, the recognition unit 120 recognizes the road surface and the damage from the road surface image. FIG. 5 is a diagram illustrating an example of a recognition result of the road surface and the damage by the recognition unit 120. In FIG. 5, the lateral crack is represented by a solid line, and the longitudinal crack is represented by a broken line, and the results are distinguished and recognized. The output unit 150 may cause the display 20 to display the recognition result of the damage. For example, the output unit 150 may display the road surface, the lateral crack, the longitudinal crack, the tortoise-shell crack, the pot hole, the road marking, the manhole, and the shadow in an arbitrary color in the recognition result.

In the second example embodiment, the prediction unit 130 predicts damage occurring on the road surface in the future for each region that is a part of the road surface image. The prediction unit 130 may predict the damage to be generated for each unit region which is a rectangular region having the same size. The unit region is set to an arbitrary size and shape, for example, a square of 50×50 pixels.

The unit region may be a unit of a region in which the recognition unit 120 recognizes the state of road surface deterioration. The unit region may be obtained by dividing a prediction target region in the road surface image. The prediction target region is a target region for predicting whether damage occurs. For example, a region of the road surface in the road surface image is set as the prediction target region. However, in a case where the road surface image includes only the road surface, the entire road surface image may be set as the prediction target region. Since it is difficult to predict road surface deterioration on a far road surface, a near road surface may be set as a prediction target, and a far road surface may be excluded from the prediction target. The range of these prediction target regions is an example, and the range is appropriately set.

The prediction unit 130 may specify a region to be a damage prediction target based on the state of the recognized road surface deterioration. The specifying of the region is to specify a position at which damage is added in the predicted image. The prediction unit 130 may specify a region in which damage of the type is predicted for each type of damage. For example, after specifying a region where a lateral crack occurs in the future, the prediction unit 130 specifies a region where a longitudinal crack occurs and a region where a tortoise-shell crack occurs.

As an example, the prediction unit 130 specifies a region including the damage recognized by the recognition unit 120. The prediction unit 130 may specify a region in which the level of recognized damage exceeds a predetermined threshold. At this time, the prediction unit 130 may extract the damage recognized for each type of damage and specify a region where the level of damage of the extracted type exceeds a predetermined threshold.

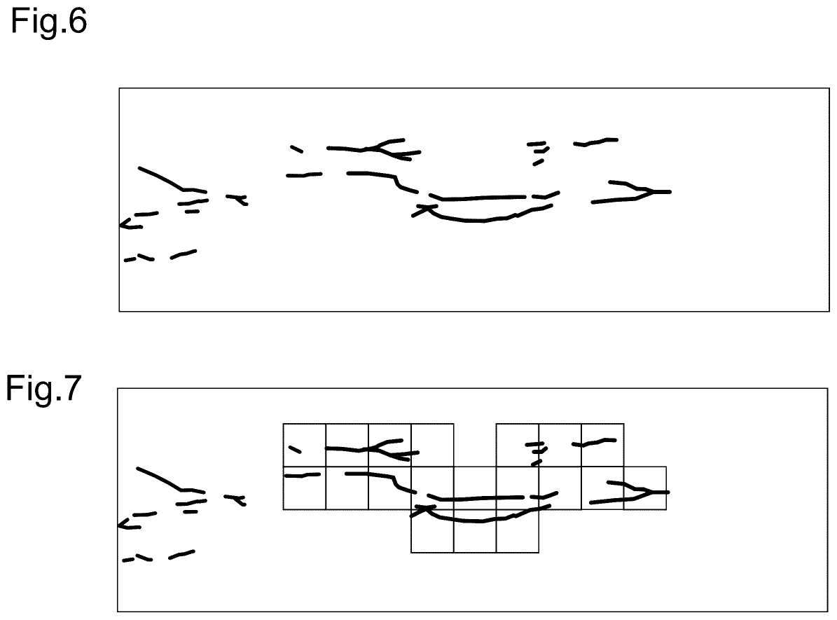

FIG. 6 is a diagram illustrating a result of extracting lateral cracks recognized in FIG. 5. FIG. 7 is a diagram illustrating a region where a lateral crack is predicted. In FIG. 7, unit regions where the level of lateral cracking exceeds a threshold are indicated by frames.

As another example, the prediction unit 130 specifies a region close to the region including the damage recognized by the recognition unit 120 as a region where the damage is predicted. At this time, the prediction unit 130 may specify both the region including the damage and the region close to the region including the damage as the region where the damage is predicted. Alternatively, the prediction unit 130 may exclude the region including the damage from the target for which the damage is predicted. That is, the image generation system 100 may specify one of the region including the damage and the region close to the region as the region where the damage is predicted.

For example, the prediction unit 130 specifies a unit region adjacent to the unit region including the damage according to the direction in which the crack extends from the tip as the deterioration progresses. The positional relationship between the unit region including the damage and the unit region specified by the prediction unit 130 may be determined in advance according to the type of deterioration to be predicted. For example, in a case where a lateral crack is recognized, the prediction unit 130 specifies each of the left and right unit regions of the unit region including the lateral crack or one of the left and right unit regions. In a case where the crack is predicted to further extend, the prediction unit 130 may specify a unit region further adjacent to the specified unit region.

As described above, the prediction unit 130 predicts damage occurring in the future on the captured road surface based on the recognized damage state. That is, the prediction unit 130 predicts damage occurring in the future in a region including the recognized road surface deterioration or a region close to the region including the road surface deterioration.

The prediction unit 130 predicts damage occurring in the future for each of the regions specified in this manner. The prediction unit 130 determines a label image related to deterioration of another road surface from the database 40. Here, the prediction unit 130 determines a label image having a size matching the size of the specified region. In a case where there is a plurality of label image candidates matching the size of the specified region, the prediction unit 130 may determine a label image randomly selected from the plurality of candidates. In a case where the region is specified for each type of damage, the prediction unit 130 determines a label image of a relevant type from the database 40 for each type of damage.

The prediction unit 130 may predict whether damage occurs in the specified region by probability. That is, the prediction unit 130 may determine a label image only for a part of the region specified as the region where the damage is predicted.

In the second example embodiment, the prediction unit 130 may integrate the plurality of specified regions and predict damage occurring in the future for each integrated region. For example, the prediction unit 130 integrates a plurality of adjacent regions including damage. Furthermore, the prediction unit 130 may integrate a region including the damage and a region close to the region including the damage. The prediction unit 130 determines a label image having a size matching the size of the integrated region.

The prediction unit 130 may separately integrate a plurality of regions including the damage and a plurality of regions close to the region including the damage. In this case, the prediction unit 130 may separately predict the damage for each integrated region of the region including the damage and the region close to the region including the damage.

It is conceivable that the larger the integrated region, the larger the damage that has occurred and the more likely the deterioration will proceed. Therefore, the prediction unit 130 may predict that advanced damage will occur as the integrated region is larger. That is, the prediction unit 130 may determine a label image representing advanced damage.

In a case where a unit region for predicting damage of the type is specified for each type, a rule for integrating the unit regions may be determined for each type of damage. For example, in the case of a lateral crack, the prediction unit 130 integrates unit regions close to the left and right in the road surface image. In the case of a longitudinal crack, the prediction unit 130 integrates unit regions vertically adjacent to each other in the road surface image. In the case of a tortoise-shell crack, the prediction unit 130 integrates the unit regions such that the integrated region has a rectangular shape.

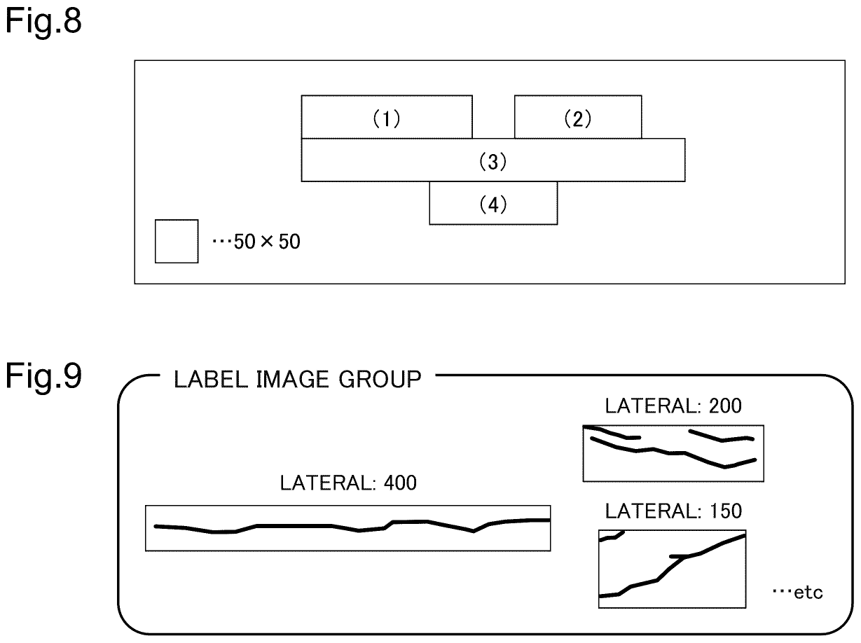

FIG. 8 is a diagram illustrating a result of integrating regions specified as regions to which lateral cracks are added in FIG. 7. FIG. 8 includes four integrated regions. FIG. 9 is a diagram illustrating an example of label images stored in the database 40. FIG. 9 illustrates a label image indicating a lateral crack. For example, the prediction unit 130 determines a label image of a lateral crack matching each of the four integration regions in FIG. 8.

A plurality of types of damage are predicted, which may result in locations where the damage is dense. Therefore, the prediction unit 130 may predict the damage again based on the recognized damage and the level of damage of the road surface where the predicted damage has occurred. For example, the prediction unit 130 specifies a region where the number of intersections of cracks is larger than a predetermined threshold on a road surface on which a lateral crack or a longitudinal crack is predicted. Then, the prediction unit 130 determines a label image of a tortoise-shell crack matching the region. The prediction unit 130 specifies a region where the density of tortoise-shell cracks is higher than a predetermined threshold on the road surface on which the tortoise-shell cracks are predicted. Then, the prediction unit 130 determines the label image of the pot hole matching the region.

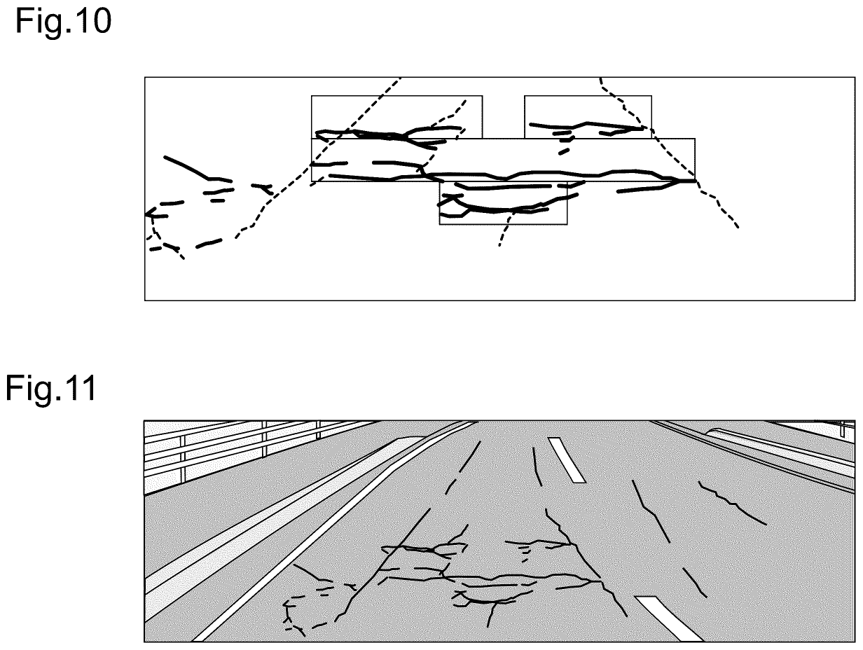

The generation unit 140 generates a predicted image representing the damage predicted by the prediction unit 130 on the road surface using the road surface image. For example, the generation unit 140 superimposes the determined label image on the recognition result of the damage from the road surface image. Here, the generation unit 140 superimposes the label image on the position predicted by the prediction unit 130. FIG. 10 is a diagram illustrating a result of superimposing, on FIG. 5, the label image indicating the lateral crack predicted in FIG. 8. The generation unit 140 similarly superimposes other types of predicted damage on FIG. 5. The generation unit 140 may generate the predicted image by inputting an image on which the label image is superimposed as illustrated in FIG. 10 to the learning model. The generation unit 140 generates, for example, a predicted image such as an image obtained by photographing a road surface. FIG. 11 is a diagram illustrating an example of a generated predicted image.

In a case where the prediction unit 130 has performed the damage prediction on the same road surface image a plurality of times, the generation unit 140 may generate the predicted image based on each prediction result. For example, the prediction unit 130 predicts damage at a plurality of future time points. Specifically, for example, the prediction unit 130 predicts damage 6 months, 12 months, and 18 months after the time point at which the road surface image is captured. At this time, the generation unit 140 creates three predicted images based on each prediction result.

The output unit 150 outputs the predicted image generated by the generation unit 140. The output unit 150 may switch and display a plurality of predicted images generated for one point one by one. According to such switching display, a moving image showing the progress of damage at one point is displayed.

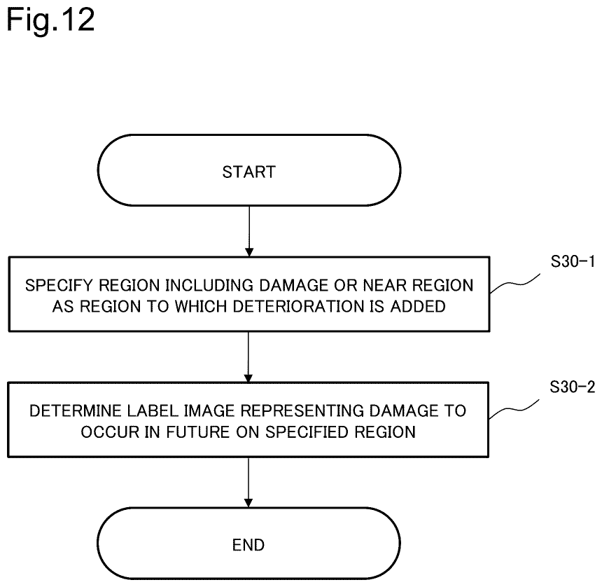

An operation of the image generation system 100 according to the second example embodiment will be briefly described. The operation of the second example embodiment is basically similar to that of the first example embodiment. In step S30 in FIG. 2, the image generation system 100 performs processing as illustrated in FIG. 12 below, for example.

FIG. 12 is a flowchart illustrating an operation example of the image generation system 100 according to the second example embodiment. The prediction unit 130 specifies a region including the damage recognized by the recognition unit 120 in a part of the road surface image as a region to which the damage is added. Alternatively, the prediction unit 130 specifies a region close to the region including the damage recognized by the recognition unit 120 in a part of the road surface image as a region to which the damage is added (step S30-1). Then, the prediction unit 130 determines a label image indicating damage occurring in the future for the specified region (step S30-2). Thereafter, the image generation system 100 performs the processing illustrated in FIG. 2.

The prediction unit 130 may execute steps S30-1 and S30-2 a plurality of times for each type of road surface deterioration.

According to the second example embodiment, the same effects as those of the first example embodiment can be obtained. In the second example embodiment, the prediction unit 130 predicts damage occurring in the future in a region including the damage or the vicinity thereof in the road surface image. Therefore, it is possible to generate a predicted image representing the damage that has progressed to the periphery of the place where the damage has already occurred on the road surface.

### Third Example Embodiment

Regarding the configuration of a third example embodiment, description of the same configuration as that of the second example embodiment will be omitted. In the third example embodiment, the prediction unit 130 specifies a region where damage will occur in the future based on the index of the future deterioration level of the captured road surface. The method will be described below.

The prediction unit 130 further determines a future deterioration level of the road surface on which the road surface image is acquired. The prediction unit 130 may determine the deterioration level having received the input from the user as the future deterioration level. The user inputs the deterioration level using the input device 21. Alternatively, the prediction unit 130 may determine the deterioration level predicted by an arbitrary method as the future deterioration level. The future deterioration level is predicted using, for example, a deterioration level recognized from the road surface image and a length of a period up to a future time point. The prediction of the deterioration level may be performed by the prediction unit 130. Alternatively, the prediction unit 130 may receive a deterioration level predicted in another device.

The deterioration level determined here is not limited to the index including the level of cracking, the number of pot holes, the size of the pot holes, or the rutting amount. As the deterioration level, any index representing damage including flatness and maintenance control index (MCI) may be used. The flatness may be represented by an International Roughness Index (IRI). The IRI is an index in which the road surface and the ride comfort of the driver are associated with each other, and represents the level of unevenness as a numerical value. The value of MCI is a minimum value of a result of calculating four definition equations using a cracking rate, a rutting amount, and flatness. The MCI decreases as the road degrades.

In the following description, a cracking rate is mainly used as the deterioration level.

The prediction unit 130 predicts that, as the deterioration progresses, new damage will also occur in a region that does not include the road surface deterioration in a part of the road surface image. Therefore, the prediction unit 130 specifies the region to which the damage is newly added. At this time, the prediction unit 130 may also specify the region including the road surface deterioration as the region to which the damage is added. Which range is specified as the region where the damage newly occurs is determined according to, for example, a difference between the deterioration level of the road surface recognized from the road surface image by the recognition unit 120 and the future deterioration level determined by the prediction unit 130.

The relationship between the deterioration level and the size of the region where damage newly occurs may be determined in advance. For example, it is assumed that it is determined that the cracking rate of the road surface increases by approximately 3% every time one unit region including the damage increases. Then, the recognition unit 120 recognizes that the cracking rate of the road surface in the original road surface image is 10%, and the prediction unit 130 determines that the future cracking rate is 30%. In this case, the prediction unit 130 determines the size of a region where a crack newly occurs as, for example, seven unit regions based on the difference value of +20%.

When the total size of the regions for which damage is predicted is determined, the prediction unit 130 specifies the position of the region. For example, a region close to a region including road surface deterioration in the road surface image is specified.

Thereafter, the prediction unit 130 predicts damage occurring in the specified region, similarly to the second example embodiment. The prediction unit 130 may integrate the region including the road surface deterioration and the region where the damage newly occurs, and predict the damage occurring in the integrated region.

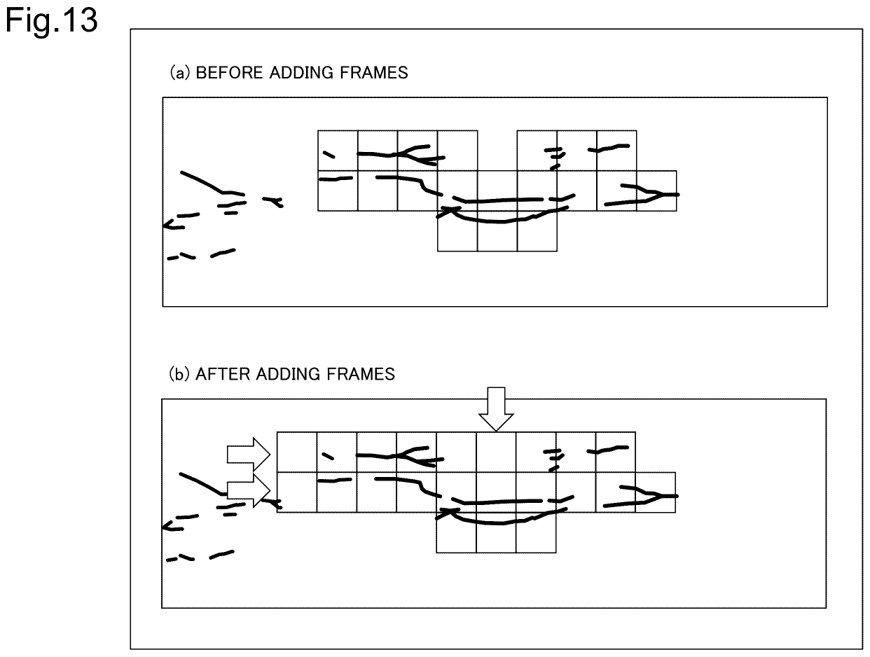

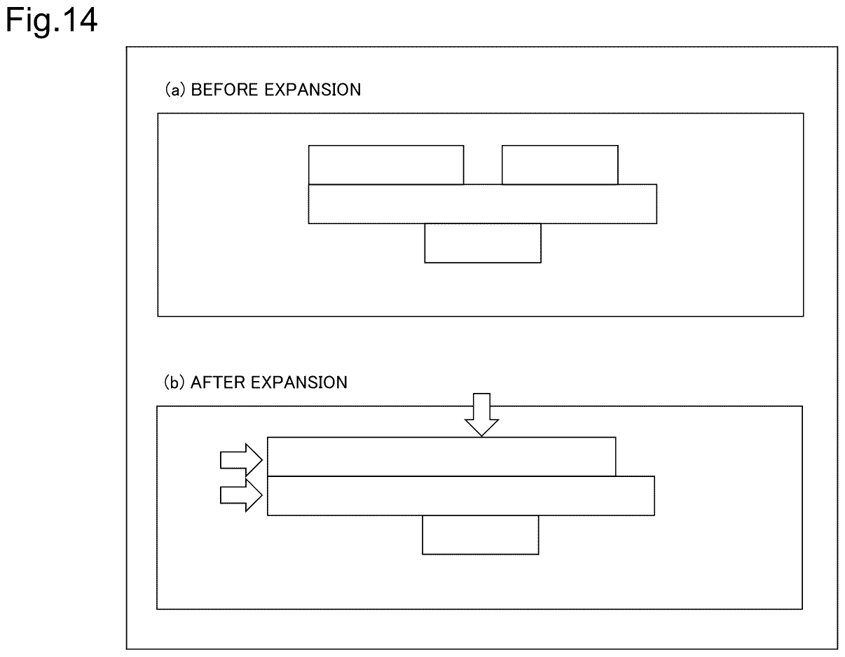

FIGS. 13 and 14 are diagrams illustrating an example of a method of expanding a region close to a region including damage in a region for which damage is predicted. (a) of FIG. 13 illustrates a state in which the prediction unit 130 specifies a unit region including a lateral crack as a region where damage is predicted. Here, the prediction unit 130 determines the size of a region where damage newly occurs as three unit regions based on the future deterioration level. For example, as illustrated in (b) of FIG. 13, the prediction unit 130 additionally specifies three unit regions close to a unit region including a lateral crack. The regions specified in (b) of FIG. 13 are integrated as illustrated in (b) of FIG. 14. Then, the prediction unit 130 predicts a lateral crack occurring in the integrated region in the future.

The prediction unit 130 may repeat the specification of the position of the region and the prediction of the damage in the region at the position until the damage is predicted in the region having a predetermined size. For example, the prediction unit 130 predicts whether damage occurs in the unit region of the specified position by probability. In a case where it is predicted that no damage occurs at the specified position, the prediction unit 130 specifies a unit region at another position. Then, the prediction unit 130 predicts whether damage occurs in a unit region at the other position by probability. In this way, the prediction unit 130 repeats the specification of the position and the prediction of the damage until the damage is added to the predetermined number of unit regions.

The prediction unit 130 may determine the total size of the region to which the damage is added and specify the region a plurality of times. That is, the prediction unit 130 predicts the damage of the specified region. Then, the prediction unit 130 may extend the region where the damage is predicted based on the predicted deterioration level of the road surface to which the damage is added and the future deterioration level. For example, the prediction unit 130 calculates the deterioration level of the road surface including both the damage recognized by the recognition unit 120 and the damage predicted by the prediction unit 130. The prediction unit 130 determines whether the calculated deterioration level of the road surface matches the determined deterioration level. The prediction unit 130 may provide a threshold and determine that the deterioration levels match when the difference between the deterioration levels is within a predetermined range. When determining that the calculated deterioration level and the determined deterioration level match, the prediction unit 130 ends the extension of the region.

For example, the regions specified in (a) of FIG. 13 are integrated as illustrated in (a) of FIG. 14. Then, the prediction unit 130 predicts a lateral crack occurring in the integrated region in the future. In a case where it is determined that the deterioration level calculated for the road surface to which the predicted lateral crack is added is lower than the determined deterioration level by the predetermined range, the prediction unit 130 extends the region where the damage is predicted. For example, the prediction unit 130 additionally specifies one unit region close to the region including the lateral crack. The prediction unit 130 may additionally specify two or more unit regions at a time. Then, the prediction unit 130 predicts a lateral crack occurring in the integrated region in the future. For example, as illustrated in (b) of FIG. 13, the prediction unit 130 specifies three unit regions close to a region including a lateral crack. Here, the prediction unit 130 may similarly predict the damage to be added for other types of damage. The prediction unit 130 repeats expansion of the specified region and prediction of damage until the deterioration level of the road surface to which the crack is added matches the determined deterioration level.

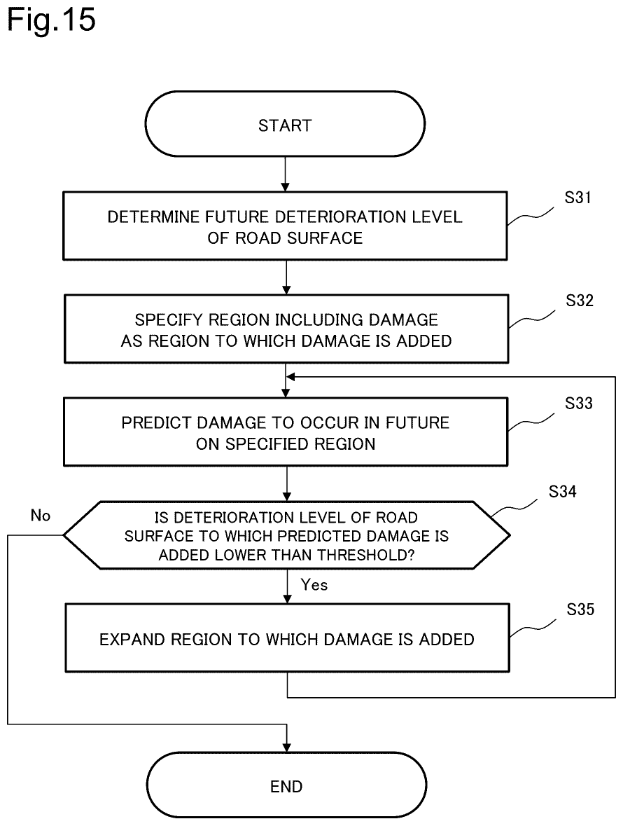

FIG. 15 is a flowchart illustrating an operation example of the image generation system 100 according to the third example embodiment. The operation of the third example embodiment is basically similar to that of the first example embodiment. In step S30 in FIG. 2, the image generation system 100 performs processing as illustrated in FIG. 15, for example.

The prediction unit 130 determines a future deterioration level of the road surface on which the road surface image is acquired (step S31). Then, the prediction unit 130 specifies a region including the damage as a region to which the damage is added (step S32). Thereafter, the prediction unit 130 predicts damage occurring in the future in the specified region (step S33). In steps S32 and S33, the prediction unit 130 may specify a region and predict damage for each of a plurality of types of damage.

Next, the prediction unit 130 determines whether the deterioration level of the road surface to which the predicted damage is added is lower than the deterioration level determined in step S31 by a predetermined range (step S34). In a case where the predicted deterioration level of the road surface to which the damage is added is lower than the threshold (step S34: Yes), the prediction unit 130 extends the region to which the damage is added (step S35).

After step S35, the prediction unit 130 executes step S33 again and predicts damage occurring in the future for the extended region. At this time, the prediction unit 130 may predict the damage for the region obtained by integrating the extension region and the originally specified region. Alternatively, the prediction unit 130 may utilize the result previously predicted for the specified region and newly predict the damage only for the extended region. Then, the prediction unit 130 executes step S34 again, and determines the deterioration level of the road surface to which the predicted damage is added.

In a case where the deterioration level of the road surface to which the predicted damage is added is equal to or greater than the threshold (step S34: No), the prediction unit 130 ends the process. Thereafter, the image generation system 100 proceeds to the operation of step S40 in FIG. 2.

According to the third example embodiment, the same effects as those of the first and second example embodiments can be obtained. £ In the second example embodiment, the prediction unit 130 specifies a region to which damage is to be added based on the future deterioration level. Therefore, it is possible to represent deterioration at an appropriate position in a predicted image.

### Modifications

The example embodiments are not limited to the examples described above, and various modifications can be made. The image generation system 100 according to each example embodiment can be modified as follows, for example.

In each example embodiment, the prediction unit 130 may further predict damage occurring on the road surface in the future according to the relative position with respect to the lane recognized from the road surface image. At this time, the recognition unit 120 recognizes the lane from the road surface image.

The relative position includes left and right positions with respect to the recognized lane. Since the wheels of the vehicle pass through both ends of the lane more frequently than the center of the lane, deterioration progresses. The road shoulder may easily collapse compared to the center of the lane. Therefore, the prediction unit 130 predicts the damage to occur according to the relative position with respect to the lane. For example, the closer the specified region is to both ends of the lane, the more the prediction unit 130 predicts the damage that has progressed.

The relative position further includes a perspective position with respect to the recognized lane. The prediction unit 130 may further calculate a difference in appearance due to perspective to predict damage. By perspective, damage appears smaller on more distant roads. Therefore, the prediction unit 130 may predict the damage for each region having a size corresponding to the position in the road surface image. For example, the prediction unit 130 specifies a smaller region for a farther road and a larger region for a closer road, and predicts damage for each of the specified regions.

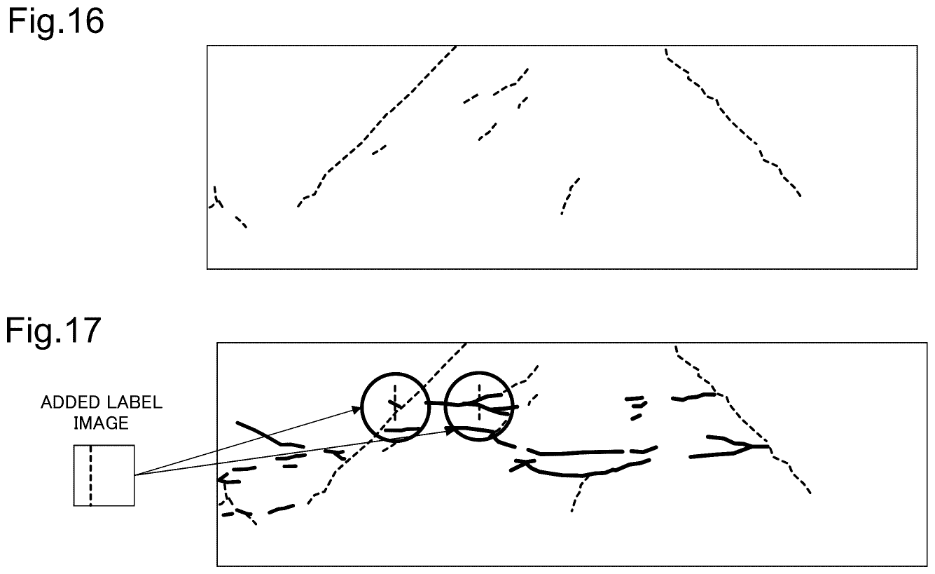

Due to perspective, a longitudinal crack appears to incline toward a farther road. FIG. 16 is a diagram illustrating a result of extracting the longitudinal cracks recognized in FIG. 5. Even in a case where longitudinal cracks actually occur in parallel, longitudinal cracks that appear inclined in the road surface image are extracted. Based on the result extracted in this manner, the prediction unit 130 specifies a region where a longitudinal crack is predicted. Then, the prediction unit 130 determines a label image of a longitudinal crack matching the specified region. At this time, in a case where the prediction unit 130 does not calculate the difference in appearance due to perspective, the generation unit 140 generates an image as illustrated in FIG. 17. FIG. 17 is a diagram illustrating a result of superimposing a label image indicating the predicted longitudinal cracks on FIG. 5. In FIG. 17, vertical longitudinal cracks have been added to the identified two regions. In order to generate a more natural predicted image, a label image indicating a longitudinal crack inclined to the right may be superimposed.

In order to express the difference in appearance of the longitudinal crack depending on the depth in such an image in the predicted image, the prediction unit 130 may tilt the longitudinal crack in the specified region as described below.

As an example, the prediction unit 130 may predict that a longitudinal crack parallel to the recognized nearby longitudinal crack will occur. As another example, the prediction unit 130 divides the road surface image into left and right parts, and inclines the longitudinal crack to be predicted toward the center of the road surface image. The prediction unit 130 inclines the longitudinal crack to be predicted more greatly as the distance from the center is longer.

Alternatively, the prediction unit 130 may first determine a vanishing point of the captured image. The position of the vanishing point in the road surface image may be determined in advance. Alternatively, the position of the vanishing point may be determined by the user for each road surface image. The vanishing point may be estimated from how an object such as a road surface, a lane marking, or a building looks by performing image recognition from the road surface image. Then, the prediction unit 130 predicts that a longitudinal crack inclined toward the vanishing point will occur.

The prediction unit 130 may incline the longitudinal crack by a method other than the method described above. The prediction unit 130 may determine to incline the label image indicating the longitudinal crack. Alternatively, the prediction unit 130 may determine a label image representing an inclined longitudinal crack. Using the image on which the label image indicating the inclined longitudinal crack determined by the prediction unit 130 is superimposed, the generation unit 140 generates a predicted image.

The prediction unit 130 may specify the region to which the repair material is added in consideration of the temporary repair of the road surface in the future. The prediction unit 130 specifies, for example, a region in which the level of damage exceeds a threshold or a region in which the level of future damage is predicted to exceed the threshold. For the temporary repair, any material including a particle spraying type, an injection type, and a spraying type is used. As the repair material, asphalt-based or cementitious materials can be used, and for example, rubber-based asphalt, resin mortar, gravel, soil, and the like are also used. However, the type of repair material is not limited thereto. Then, the prediction unit 130 predicts a repair material to be used in the future for the specified region. The generation unit 140 generates a predicted image representing the predicted repair material on the road surface.

Depending on the region where the road surface is present, the material of the pavement to be used and the repair material may be different, and the damage to occur and the appearance after repair may be different. The traffic volume varies depending on the region where the road surface is present, and the appearance of the damage that occurs may vary. For example, a pot hole is more likely to occur on a road where many heavy vehicles pass. Therefore, the prediction unit 130 may further predict the damage or the repair material based on the region of the region where the road surface exists. The prediction unit 130 specifies the region where the road surface exists by using the position information of the point where the image is captured, which is acquired by acquisition unit 110. Then, the prediction unit 130 predicts the damage with reference to the damage in the specified region and the regional characteristics of the repair material. The regional characteristics may be stored in the database 40.

As the regional characteristics of damage, the average area size, shape, and likelihood of occurrence of pot holes for each region can be stored. For example, the prediction unit 130 predicts a pot hole relevant to the size and shape of the area stored for the region where the road surface exists as damage to occur in the future. The prediction unit 180 may predict the number of pot holes to occur according to the likelihood of occurrence of pot holes. The traffic volume of heavy vehicles may be stored as the regional characteristics of the damage. For example, the prediction unit 130 predicts that the larger the traffic volume, the larger the area, and a pot hole having a more advanced shape will be generated on the road surface of the place. The prediction unit 130 may predict that more pot holes will be generated as the traffic volume is larger.

As the regional characteristics of the damage, the material of the pavement to be used may be stored for each place. The prediction unit 130 predicts color damage that occurs on the road surface of the stored material of the pavement. For example, the color of the pot hole varies depending on the material of the pavement used. The prediction unit 130 predicts the pot hole of the stored color as damage occurring on the road surface of the place in the future. The prediction unit 130 may convert the color of the pot hole indicated by the label image into a color relevant to the regional characteristics and determine the converted label image. As the regional characteristics of the damage, for example, whether the color of the generated pot hole is black or white may be stored for each place.

Furthermore, the color, type, and manner of painting of the repair material may be stored as the regional characteristics of the damage. The color of the repair material used for repair varies depending on the region such as black and transparent. How to paint the repair material also differs depending on whether the repair material is lightly painted or more painted against deterioration. The prediction unit 130 determines a label image relevant to the stored color, type, and coating method of the repair material.

In each example embodiment, the prediction unit 130 may predict the type of damage to occur based on the index of the future deterioration level of the road surface. The prediction unit 130 may predict the level of damage based on the future deterioration level of the road surface. The method for determining the deterioration level is as described in the third example embodiment. The prediction unit 130 predicts the damage to be increased in a case where the deterioration level of the road surface recognized from the road surface image by the recognition unit 120 advances to the determined deterioration level.

The relationship between the increasing deterioration level and the damage that occurs when the deterioration occurs may be determined in advance. A damage relationship of a predetermined deterioration level is exemplified below.
In a case where the cracking rate increases by 5%, one small crack increases. In a case where there is already a crack, one crack increases from the existing crack at the start point.
In a case where the cracking rate increases by 10%, continuous cracking of a predetermined length increases by one. In a case where there is already a crack, one crack increases to intersect the crack.
In a case where the cracking rate increases by 20%, two cracks in the direction traversing the road surface increase to the left and right of the road surface.
In a case where the cracking rate increases by 30%, tortoise-shell cracks will occur.
In a case where the cracking rate increases by 40%, fine particles in the roadbed material of the pavement appear, and white cracking occurs.

Furthermore, the prediction unit 130 may predict the damage to occur on the road surface at a future time point according to a season at a future time point. For example, since the pavement expands in summer, the cracks become thick, and in winter, the cracks become thin due to shrinkage. Therefore, the prediction unit 130 may predict the thickness of a crack to occur according to a season at a future time point. Deterioration is likely to proceed due to the influence of water in rainy seasons and snow melting seasons. Therefore, the prediction unit 130 may predict the damage in consideration of the progress rate of the deterioration according to the season at a future time point.

### Hardware Configuration

In the above-described example embodiments, each component of the image generation system 100 represents a block of functional units. A part or all of each component of the image generation system 100 may be achieved by any combination of a computer 500 and the program.

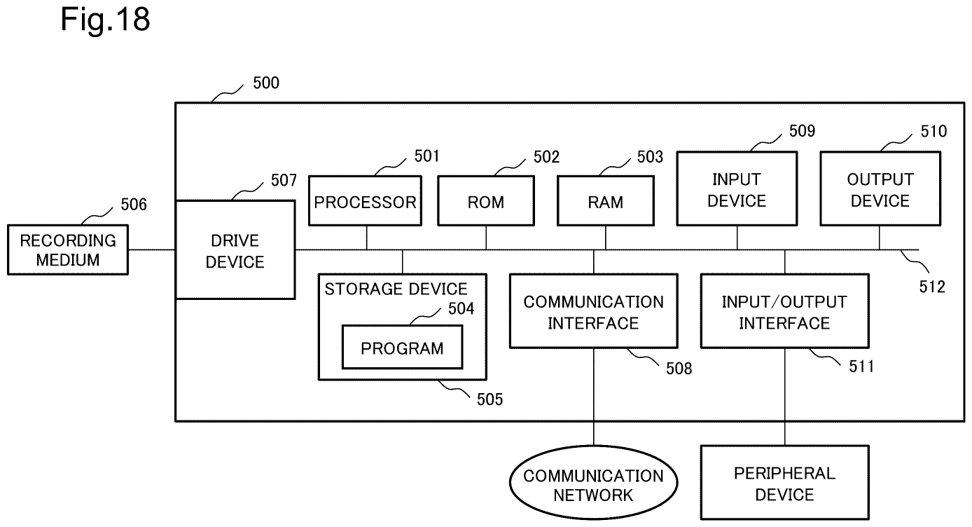

FIG. 18 is a block diagram illustrating an exemplary hardware configuration of a computer 500. Referring to FIG. 18, the computer 500 includes, for example, a processor 501, a read only memory (ROM) 502, a random access memory (RAM) 503, a program 504, a storage device 505, a drive device 507, a communication interface 508, an input device 509, an input/output interface 511, and a bus 512.

The processor 501 controls the entire computer 500. Examples of the processor 501 include a central processing unit (CPU) and the like. The number of processors 501 is not particularly limited, and the number of processors 501 is one or more.

The program 504 includes an instruction for achieving each function of the image generation system 100. The program 504 is stored in advance in the ROM 502, the RAM 503, and the storage device 505. The processor 501 achieves each function of the image generation system 100 by executing instructions included in the program 504. The RAM 503 may store data to be processed in each function of the image generation system 100. For example, the captured road surface image may be stored in the RAM 503 of the computer 500.

The drive device 507 reads and writes a recording medium 506. The communication interface 508 provides an interface with a communication network. The input device 509 is, for example, a mouse, a keyboard, or the like, and receives an input of information from the administrator. The output device 510 is, for example, a display, and outputs (displays) information to an administrator or the like. The input/output interface 511 provides an interface with a peripheral device. The bus 512 connects the components of the hardware. The program 504 may be supplied to the processor 501 via the communication network, or may be stored in advance in the recording medium 506, and the drive device 507 may read the program and supply the program to the processor 501.

The hardware configuration illustrated in FIG. 18 is an example, and other components may be added or some components may not be included.

There are various modifications of the implementation method of the image generation system 100. For example, the image generation system 100 may be achieved by an arbitrary combination of a computer and a program different for each component. A plurality of components included in the image generation system 100 may be achieved by any combination of one computer and a program.

At least a part of the image generation system 100 may be provided in a software as a service (Saas) format. That is, at least a part of the functions for achieving the image generation system 100 may be executed by software executed via a network.

Although the present disclosure has been particularly shown and described with reference to the present example embodiment, the present disclosure is not limited to the above example embodiment. It will be understood by those of ordinary skill in the art that various changes in form and details may be made therein without departing from the spirit and scope of the present disclosure as defined by the claims. The configurations in the example embodiments can be combined with each other without departing from the scope of the present disclosure.

Some or all of the above example embodiments may be described as the following Supplementary Notes, but are not limited to the following.

### Supplementary Note 1

An image generation system including:
an acquisition means for acquiring a road surface image in which a road surface is imaged;
a recognition means for recognizing road surface deterioration from the road surface image;
a prediction means for predicting future damage occurring on the imaged road surface based on a state of the recognized road surface deterioration;
a generation means for generating a predicted image representing the predicted damage on the road surface using the road surface image; and
an output means for outputting the predicted image.

### Supplementary Note 2

The image generation system according to Supplementary Note 1, in which
the prediction means predicts the damage to occur based on a position of a recognized damage.

### Supplementary Note 3

The image generation system according to Supplementary Note 2, in which
the prediction means predicts that the damage occurs in a vicinity of a recognized damage.

### Supplementary Note 4

The image generation system according to Supplementary Note 3, in which
the prediction means predicts that the damage occurs in a direction in which the recognized damage extends.

### Supplementary Note 5

The image generation system according to any one of Supplementary Notes 1 to 4, in which
the prediction means predicts the damage to occur based on a level of recognized damage.

### Supplementary Note 6

The image generation system according to Supplementary Note 5, in which
the prediction means predicts occurrence of a tortoise-shell crack based on a number of intersections between linear cracks.

### Supplementary Note 7

The image generation system according to Supplementary Note 5 or 6, in which
the prediction means predicts occurrence of a pot hole based on a density of tortoise-shell cracks.

### Supplementary Note 8

The image generation system according to any one of Supplementary Notes 1 to 7, in which
the prediction means specifies a region where the damage occurs based on an index of a future deterioration level of the road surface.

### Supplementary Note 9

The image generation system according to any one of Supplementary Notes 1 to 8, in which
the prediction means predicts a type of the damage to occur based on an index of a future deterioration level of the road surface.

### Supplementary Note 10

The image generation system according to any one of Supplementary Notes 1 to 9, in which
the recognition means recognizes a lane from the road surface image, and
the prediction means predicts the damage to occur according to a relative position with respect to the recognized lane.

### Supplementary Note 11

The image generation system according to any one of Supplementary Notes 1 to 10, in which
the prediction means predicts the damage to occur based on a regional characteristic of a region where the road surface exists.

### Supplementary Note 12

An image generation method including:
acquiring a road surface image in which a road surface is imaged;
recognizing road surface deterioration from the road surface image;
predicting damage occurring in a future on the imaged road surface based on a state of the recognized road surface deterioration;
generating a predicted image representing the predicted damage on the road surface using the road surface image; and
outputting the predicted image.

### Supplementary Note 13

A recording medium that non-transiently records a program for causing a computer to execute:
acquiring a road surface image in which a road surface is imaged;
recognizing road surface deterioration from the road surface image;
predicting damage occurring in a future on the imaged road surface based on a state of the recognized road surface deterioration;
generating a predicted image representing the predicted damage on the road surface using the road surface image; and
outputting the predicted image.

### REFERENCE SIGNS LIST

100 image generation system
110 acquisition unit
120 recognition unit
130 prediction unit
140 generation unit
150 output unit
10 imaging device
11 moving body
20 display
21 input device
30 communication network
40 database

What is claimed is:

1. An image generation system comprising:
at least one memory storing instructions; and
at least one processor configured to execute the instructions to:
acquire road surface image in which a road surface is imaged;
recognize road surface deterioration from the road surface image;
predict future damage occurring on the imaged road surface based on a state of the recognized road surface deterioration;
generate a predicted image representing the predicted damage on the road surface using the road surface image; and
output the predicted image.

2. The image generation system according to claim 1, wherein the at least one processor is further configured to execute the instructions to:
predict the damage to occur based on a position of a recognized damage.

3. The image generation system according to claim 2, wherein the at least one processor is further configured to execute the instructions to:
predict that the damage occurs in a vicinity of the recognized damage.

4. The image generation system according to claim 3, wherein the at least one processor is further configured to execute the instructions to:
predict that the damage occurs in a direction in which the recognized damage extends.

5. The image generation system according to claim 1, wherein the at least one processor is further configured to execute the instructions to:
predict the damage to occur based on a level of recognized damage.

6. The image generation system according to claim 5, wherein the at least one processor is further configured to execute the instructions to:
predict occurrence of a tortoise-shell crack based on a number of intersections between linear cracks.

7. The image generation system according to claim 5, wherein the at least one processor is further configured to execute the instructions to:
predict occurrence of a pot hole based on a density of tortoise-shell cracks.

8. The image generation system according to claim 1, wherein the at least one processor is further configured to execute the instructions to:
predict a region where the damage occurs based on an index of a future deterioration level of the road surface.

9. The image generation system according to claim 1, wherein the at least one processor is further configured to execute the instructions to:
predict a type of the damage to occur based on an index of a future deterioration level of the road surface.

10. The image generation system according to claim 1, wherein the at least one processor is further configured to execute the instructions to:
recognize a lane from the road surface image, and
predict the damage to occur according to a relative position with respect to the recognized lane.

11. The image generation system according to claim 1, wherein the at least one processor is further configured to execute the instructions to:
predict the damage to occur based on a regional characteristic of a region where the road surface exists.

12. An image generation method comprising:
acquiring a road surface image in which a road surface is imaged;
recognizing road surface deterioration from the road surface image;
predicting damage occurring in a future on the imaged road surface based on a state of the recognized road surface deterioration;
generating a predicted image representing the predicted damage on the road surface using the road surface image; and
outputting the predicted image.

13. A non-transitory computer-readable recording medium that records a program for causing a computer to execute:
acquiring a road surface image in which a road surface is imaged;
recognizing road surface deterioration from the road surface image;
predicting damage occurring in a future on the imaged road surface based on a state of the recognized road surface deterioration;
generating a predicted image representing the predicted damage on the road surface using the road surface image; and
outputting the predicted image.
